(19) United States
(12) Patent Application Publication
(10) Pub. No.: US 2026/0001377 A1
(43) Pub. Date: Jan. 1, 2026

(54) AGRICULTURAL HEADER TRANSPORT SYSTEM

(71) Applicant: Deere & Company, Moline, IL (US)

(72) Inventors: SCOTT N. CLARK, BETTENDORF, IA (US); JOHN P. ANDRUCH, III, LE CLAIRE, IA (US); FEDERICO PARDINA-MALBRAN, FORT COLLINS, CO (US); AARON S. RITTER, MILAN, IL (US)

(21) Appl. No.: 18/757,859

(22) Filed: Jun. 28, 2024

(51) Int. Cl. B60D 1/46; A01B 69/04; A01D 75/00; G06V 20/58

(52) U.S. Cl. CPC B60D 1/46; A01B 69/008; A01D 75/004; G06V 20/58

(57) ABSTRACT

A method for aligning an agricultural machine with a tow vehicle for connection therebetween may include determining a movement profile of a tongue of the agricultural machine relative to a portion of the agricultural machine, the movement profile corresponding to a plurality of available positions of the tongue along a range of motion; identifying a target of the tow vehicle; maneuvering one of the tow vehicle or the agricultural machine relative to the other of the tow vehicle or the agricultural machine; and ceasing maneuvering of the tow vehicle or the agricultural machine relative to the other of the tow vehicle or the agricultural machine when a position of the target corresponds with one of the plurality of the available positions of the tongue.

### FIELD OF THE DISCLOSURE

The present disclosure relates generally to apparatuses, systems, and methods for positioning an agricultural machine relative to a tow vehicle, for example, for the purpose of the agricultural machine being coupled to and transported by the tow vehicle from one location to another.

### BACKGROUND OF THE DISCLOSURE

In the course of performing an agricultural operation, the agricultural operation may need to be performed at a plurality of different locations. In some cases, one or more of those locations are remote from one or more other locations. An agricultural header used to perform the agricultural operation at the different locations may need to be removed from a harvester, such as a combine harvester, prior to transport to another location. For example, transport from one location to another may involve transport along a roadway, which may require removal of the agricultural header from the harvester due to space limitations existing along the roadway.

### SUMMARY OF THE DISCLOSURE

A first aspect of the present disclosure may be directed to a method for aligning an agricultural machine with a tow vehicle for connection therebetween. The method may include determining, with one or more processors, a movement profile of a tongue of the agricultural machine relative to a portion of the agricultural machine, the movement profile corresponding to a plurality of available positions of the tongue along a range of motion; identifying, with the one or more processors, a target of the tow vehicle; maneuvering one of the tow vehicle or the agricultural machine relative to the other of the tow vehicle or the agricultural machine; and ceasing maneuvering of the tow vehicle or the agricultural machine relative to the other of the tow vehicle or the agricultural machine when a position of the target corresponds with one of the plurality of the available positions of the tongue.

Another aspect of the present disclosure is directed to a system to arrange a tow vehicle and an agricultural machine relative to each other for connection. The system may include one or more processors and a non-transitory computer-readable storage medium coupled to the one or more processors and storing programming instructions for execution by the one or more processors. The programming instructions instruct the one or more processors to determine a movement profile of a tongue of the relative to a portion of the agricultural machine, the profile corresponding to a plurality of available positions of the tongue along a range of motion; identify a target of the tow vehicle; maneuver one of the tow vehicle or the agricultural machine relative to the other of the tow vehicle or the agricultural machine; and cease maneuvering of the tow vehicle or the agricultural machine relative to the other of the tow vehicle or the agricultural machine when a position of the target corresponds with one of the plurality of available positions of the tongue.

The various aspects of the present disclosure may include one or more of the following features. A position of the tongue may be altered along the range of motion to cause a position of a coupler provided on the tongue to correspond to the position of the target. Altering a position of the tongue along the range of motion to cause a coupler provided on the tongue to correspond to the position of the target may include: actuating, in response to a first signal from the one or more processors, a first actuator coupled to the tongue of the agricultural machine; moving the tongue in response to actuation of the first actuator; determining, with the one or more processors, when the position of the coupler corresponds to the position of the target; and ceasing actuation of the first actuator when the position of the coupler is determined to correspond to the position of the target. The target may be a hitch of the tow vehicle. the coupler may be engaged with the hitch. Engaging the coupler with the hitch may include altering a vertical position of at least a portion of the tongue relative to the hitch. Altering the vertical position of the at least a portion of the tongue relative to the hitch may include actuating, in response to a second signal from the one or more processors, a second actuator to alter the vertical position of the at least portion of the tongue relative to the hitch. The method may also include: sensing, with one or more sensors electronically connected to the one or more processors, a location of the agricultural machine; sensing, with the one or more sensors electronically connected to the one or more processors, a position of the tongue of the agricultural machine; and defining a curve representing a plurality of available locations of the coupler corresponding to the movement profile of the tongue. Ceasing maneuvering of the tow vehicle or the agricultural machine relative to other of the tow vehicle or the agricultural machine when a position of the target aligns with one of the plurality of available positions of the tongue may include ceasing movement of the tow vehicle or the agricultural machine when a position of the target corresponds to a location along the curve. The method may also include: sensing, with one or more sensors, an area adjacent to the tow vehicle; generating a sensor output representative of the area; detecting, with the one or more processors, a tongue of the agricultural machine in the area using the sensor output; and determining, with the one or more processors, the range of motion of the tongue relative to the portion of the agricultural machine. The method may also include detecting, with the one or more processors, that the agricultural machine is present in the area using the sensor output. Maneuvering one of the tow vehicle or the agricultural machine relative to the other of the tow vehicle or the agricultural machine may include operating a propulsion system of the tow vehicle or the agricultural machine to move one of the tow vehicle or the agricultural machine relative to the other of the tow vehicle or the agricultural machine. Maneuvering one of the tow vehicle or the agricultural machine relative to the other of the tow vehicle or the agricultural machine may include operating one or more of a steering system or a propulsion system of at least one of the tow vehicle or the agricultural machine.

The various aspects of the present disclosure may include one or more of the following features. The programming instructions may further instruct the one or more processors to alter a position of the tongue along the range of motion to cause a position of a coupler provided on the tongue to correspond to the position of the target. The programming instructions that instruct the one or more processors to alter a position of the tongue along the range of motion to cause a position of a coupler provided on the tongue to correspond to the position of the target may include programming instructions that instruct the one or more processors to: actuate a first actuator coupled to the tongue of the agricultural machine; move the tongue in response to actuation of the first actuator; determine when the position of the coupler corresponds to the position of the target; and cease actuation of the first actuator when the position of the coupler is determined to correspond to the position of the target. The target may be a hitch of the tow vehicle. The programming instructions may further instruct the one or more processors to engaging the coupler with the hitch. The programming instructions may further instruct the one or more processors to engage the coupler with the hitch. The programming instructions that instruct the one or more processors to alter the vertical position of the at least a portion of the tongue relative to the hitch may include programming instructions that instruct the one or more processors to actuate a second actuator to alter the vertical position of the at least portion of the tongue relative to the hitch. The programming instructions further instruct the one or more processors to: sense, with one or more sensors, a location of the agricultural machine; sense, with the one or more sensors, a position of the tongue of the agricultural machine; and define a curve representing a plurality of available locations of the coupler corresponding to the movement profile of the tongue. The programming instructions that instruct the one or more processors to cease maneuvering of the tow vehicle or the agricultural machine relative to other of the tow vehicle or the agricultural machine when a position of the target aligns with one of the plurality of available positions of the tongue may include programming instructions that instruct the one or more processors to cease movement of the tow vehicle or the agricultural machine when a position of the target corresponds to a location along the curve. The programming instructions may further instruct the one or more processors to: sense, with one or more sensors, an area adjacent to the tow vehicle; generate a sensor output representative of the area; detect a tongue of the agricultural machine in the area using the sensor output; and determine the range of motion of the tongue relative to the portion of the agricultural machine. The programming instructions may further instruct the one or more processors to detect that the agricultural machine is present in the area using the sensor output. The programming instructions that instruct the one or more processors to maneuver one of the tow vehicle or the agricultural machine relative to the other of the tow vehicle or the agricultural machine may include programming instructions that instruct the one or more processors to operate one or more of a steering system or a propulsion system of at least one of the tow vehicle or the agricultural machine.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a side view with some schematic details of an example combine harvester connected with a header, according to some implementations of the present disclosure.

FIG. 2 is a side view of the combine harvester of FIG. 1 with the header positioned on a trailer located behind the combine harvester, according so some implementations of the present disclosure.

FIG. 3 is a detail view of a portion of a trailer shown in FIG. 2.

FIG. 4 is a side view of an example header having extendable and retractable ground engaging components, according so some implementations of the present disclosure.

FIG. 5 is a detail view of a portion of the header of FIG. 4.

FIG. 6 is a schematic view of an example electronic control system operable to control operation of various systems of an agricultural machine, according to some implementations of the present disclosure.

FIG. 7 is an example image collected by an image sensor showing a relationship of an agricultural machine relative to a tow vehicle, according to some implementations of the present disclosure.

FIG. 8 is another example image displaying a movement profile of a tongue of an agricultural machine, according to some implementations of the present disclosure.

FIG. 9 is another example image that shows an agricultural header transport system having advanced towards a tow vehicle, according to some implementations of the present disclosure.

FIG. 10 are views of various example propulsion input devices, according to some implementations of the present disclosure.

FIG. 11 is a flowchart of an example method for controlling movement of an agricultural machine, according to some implementations of the present disclosure.

FIG. 12 is a flowchart of an example method for aligning an agricultural machine with a tow vehicle for connecting of the agricultural machine and the tow vehicle, according to some implementations of the present disclosure.

FIG. 13 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Words of orientation, such as “up,” “down,” “top,” “bottom,” “above,” “below,” “leading,” “trailing,” “front,” “back,” “forward,” and “rearward,” used in the context of the provided examples, would be understood by one skilled in the art and are not intended to be limiting to the disclosure. For example, for a particular type of vehicle in a conventional configuration and orientation and being operated in a conventional manner, one skilled in the art would understand these terms in the context in which they are used and as those terms apply to a particular vehicle. For example, one skilled in the art would appreciate what the forward direction is in the context of a direction that an agricultural harvester normally moves when actively harvesting crop during a crop harvesting operation. Further, one skilled in the art would appreciate what the reverse direction would be for the agricultural harvester during normal operation of the agricultural harvester.

Additionally, the term “forward” (and the like) corresponds to a forward direction of travel of a work machine (e.g., header or combine harvester), such as during a harvesting operation. Likewise, the term “rearward” or “reverse” (and the like) corresponds to a direction opposite the forward direction of travel. In this regard, for example, a “forward facing” feature on a header may generally face in the direction that the head travels during normal operation, while a “rearward facing” feature may generally face opposite that direction.

Also as used herein, with respect to a work machine, unless otherwise defined or limited, the term “leading” (and the like) indicates a direction of travel of the work machine during normal operation (e.g., the forward direction of travel of a harvester vehicle carrying a header) or indicates a position on a work machine of a portion of the work machine that is ahead of another component in the context of a direction of movement of the work machine. Similarly, the term “trailing” (and the like) indicates a direction that is opposite the leading direction or indicates a position on a work machine of a portion of the work machine that trails or is behind of another component in the context of a direction of movement of the work machine. In this regard, for example, a “leading” edge of a header may be generally disposed at the front of the header, with respect to the direction travel of the header during normal operation (e.g., as carried by a combine harvester). Likewise, a “trailing” edge of a header may be generally disposed at the back of the header opposite the leading edge, with respect to the direction of travel of the header during normal operation.

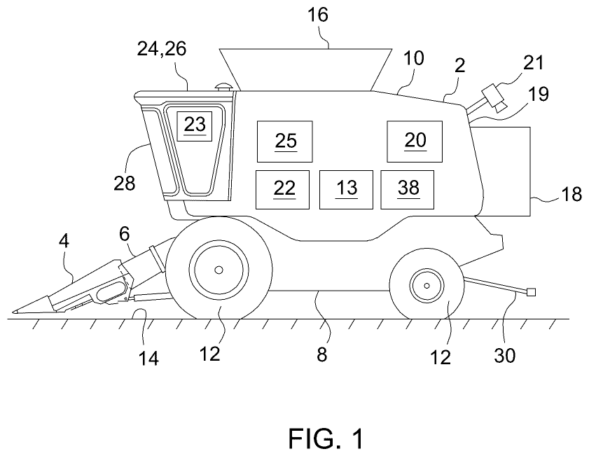

FIG. 1 is a side view of an example combine harvester 2 with an example header 4 connected to a feederhouse 6 of the combine harvester 2. Although a combine harvester is illustrated in FIG. 1, the scope of the present disclosure encompasses other types of agricultural machines. For example, the present disclosure encompasses forage harvesters (e.g., self-propelled forage harvesters) and other types of agricultural harvesters. The combine harvester 2 includes a frame 8, a body 10 mounted to the frame 8, and ground engaging components 12 coupled to the frame 8. The ground engaging components 12 operate to move the combine harvester 2 over a surface, such as the ground 14. Example ground engaging components 12 include wheels (e.g., a combination of wheels and tires), tracks, or other components or assemblies that function to move the agricultural harvester 2 over a surface. The combine harvester 2 also includes a steering system 13 that operates to move (e.g., pivot) one or more of the ground engaging components 12 (e.g., the two rear ground engaging components 12) to steer the combine harvester 2. In some instances, the forward ground engaging components 12 are steered. In still other implementations, all ground engaging components 12 are movable to effectuate steering of the combine harvester 2. In some implementations, the steering system causes one portion of a vehicle to move relative to another portion of the vehicle to effectuate steering, such as in the context of an articulated machine. The combine harvester 2 includes processing components within the body 10 that process the harvested crop. Clean grain extracted from the harvested crop is stored within a grain tank 16, and residue from the harvested crop is handled by a residue system 18. The residue system 18 expels the residue from the combine harvester 2, such as in a windrow or a distribution spread behind the combine harvester 2. The residue system 18 may include a chopper that chops residue, e.g., straw and other non-grain components of the harvested crop, prior to expulsion of the residue from the combine harvester 2. In some instances, the residue system 18 is movable between a raised position and a lowered position. When the residue system 18 is raised, a vertical distance between at least a portion of the residue system 18 and the ground 14 is increased. When the residue system 18 is lowered, a vertical distance between at least a portion of the residue system 18 and the ground 14 is decreased. All or part of the residue system 18 is provided at an aft end 19 of the combine harvester 2.

During a harvesting operation, the header 4 operates to harvest crop and transport the harvested crop to the feederhouse 6. Example headers 4 include corn headers, draper headers, and pickup headers. Other types of headers 4 are also within the scope of the present disclosure. The feederhouse 6 conducts the crop into the body 10 for processing by the processing components. The resulting clean grain is transported to the grain tank 16, and the resulting crop residue is conveyed to the residue system 18, from which the residue is expelled from the combine harvester 2.

The combine harvester 2 also includes a propulsion system 20 and a brake system 22. The propulsion system 20 operates to propel the combine harvester 2, such as by driving one or more of the ground engaging components 12 to move the combine harvester 2 over the ground 14. In some instances, the propulsion system 20 includes one or more of an engine (e.g., an internal combustion engine), a motor, an energy source (e.g., a liquid fuel or electrical energy source or storage device, e.g., one or more batteries), a transmission, and a drive system (e.g., one or more shafts, belts, or other power transmission components). In some implementations, the transmission is operable to cause the propulsion system to operate in a first configuration (so as to cause movement in a first direction, e.g., a forward direction) or a second configuration (so as to cause movement in a second direction, e.g., a reverse direction).

The brake system 22 may include, for example, a hydraulic system to pressurize and convey hydraulic fluid to one or more brake actuators (e.g., calipers, drum brakes, or other devices configured to apply a brake force) and rotors or other components configured to interact with the brake actuators to apply a brake force to the combine harvester 2. The combine harvester 2 also includes an operator station 24. In the illustrated example, the operator station 24 is, is included in, or is part of a cab 26 located at a forward end 28 of the combine harvester 2.

The combine harvester 2 also includes one or more sensors 21, such as one or more image capture devices. Example image capture devices include cameras (e.g., optical or visual radiation cameras or red, green, blue (RGB) cameras), lidar, radar (e.g., long-range terahertz radar, frequency-modulated continuous wave radar (FMCW), ground penetrating radar), ultrasonic sensors, thermal sensors (e.g., thermal cameras), stereo cameras, laser vibrometers, infrared nuclear magnetic resonance (NMR) cameras, infrared short-wave infrared (SWIR) cameras, infrared terahertz sensors, other sensors operable to capture or generate an image representative of an area being imaged. In some instances, the images provided by the one or more image devices 21 are displayed to the operator, such as via one or more displays 23 included with the operator station 24, within the cab 26, or otherwise visible to the operator during operation of the combine harvester from the operator station 24. In some instances, the one or more sensors 21 are configured to image that includes an area adjacent to an aft end of the combine harvester 2. In this way, the one or more sensors 21 image that includes a hitch 30 of the combine harvester 2 and an area adjacent thereto.

The combine harvester 2 also includes an electronic controller 25. In some instances, the controller 25 may be a computer or computer system, such as computer 1302 or computer system 1300 described in more detail below. The electronic controller 25 is configured to control one or more operations of the combine harvester 2 in response to input received, such as from the sensor 21. For example, in response to input from the sensor 21, e.g., input from an image capture device, or another sensor (e.g., a sensor provided on an agricultural header transport system or header), the electronic controller 25 is operable to control operation of steering system 13, brake system 22, the propulsion system 20, or a combination of these. In some implementations, the electronic controller 25 may be configured to control other aspects of the combine harvester 2, such as one or more processing systems of the combine harvester 2 or a light system of the combine harvester 2.

An agricultural header transport system, as used herein, is intended to encompass agricultural machines such as header transport systems that receive a header for transport, such as trailer 34, described in more details below, as well as a header that includes transport functionality, such as header 400, described in more detail below. Therefore, an agricultural header transport system, as used herein, is intended to encompass a transport device, such as the trailer 34, that is operable to receive an agricultural header for transport of the agricultural header, as described herein, as well as an agricultural header, such as agricultural header 400, that includes functionality as described herein.

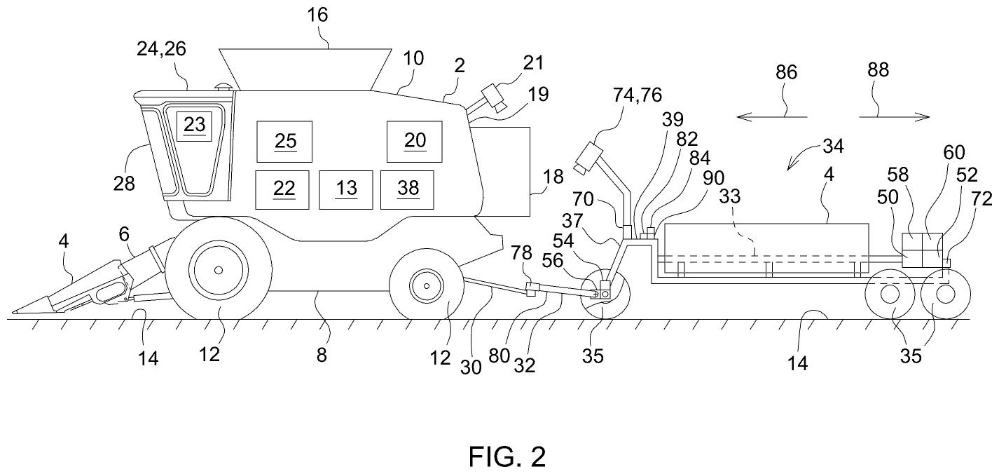

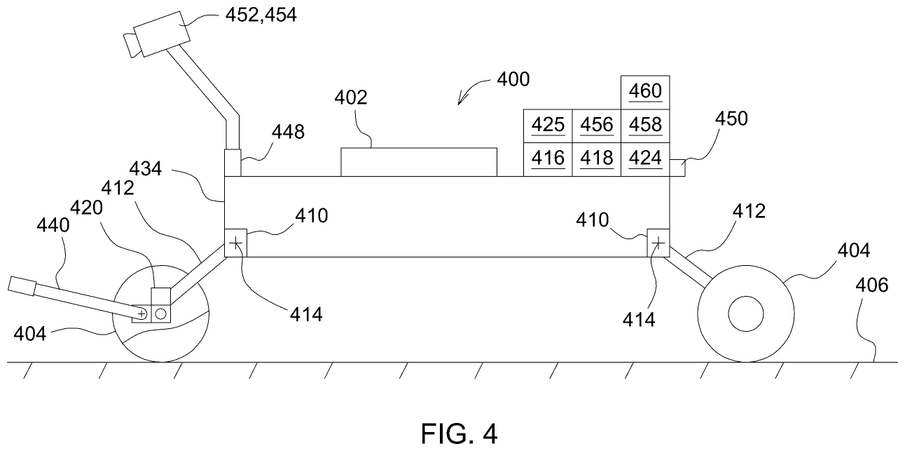

Referring to FIGS. 1 and 2, the combine harvester 2 also includes the hitch 30. The hitch 30 is configured to connect to the header 4 directly or indirectly. For example, the hitch 30, in some instances, connects to a tongue 32 of a trailer 34 used to transport the header 4. In some instances, the hitch 30 includes any type of coupler that is operable to couple to the trailer 34, such as by releasably coupling to a part of the tongue 32 of the trailer 34, to facilitate transport of the trailer 34 by the combine harvester 2. To transport the header 4, the header 4 is placed onto a platform 33 of the trailer 34. The header 4 rests on, and in some instances secured to, the platform 33 for transportation of the header 4 on the trailer 34 from one location to another. An example in which the header 4 is provided on the trailer 34 is described. However, this disclosure is applicable to and encompasses headers that can be pulled by a combine harvester without the use of a trailer, as shown, for example, in FIG. 4.

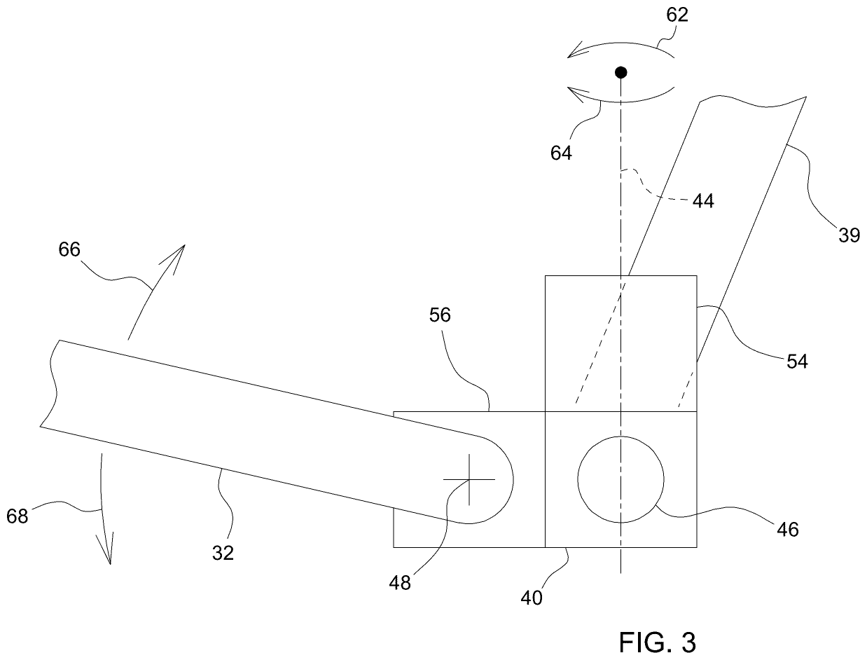

Referring to FIG. 2, the trailer 34 includes ground engaging components 35, such as wheels (e.g., a combination of tires and wheels) or tracks, that allows the trailer 34 to move over the ground 14. The ground engaging components 35 are mounted to the platform 33. A forward end 37 of the trailer 34 includes a beam 39 that is connected to or forms part of the platform 33. Referring to FIG. 3, an axle assembly 40 is pivotably mounted to an end 42 of the beam 39. The axle assembly 40 is pivotable about vertical axis 44. The axle assembly 40 includes an axle 46 on which the ground engaging components 35 are mounted. In some implementations, the ground engaging components 35 are rotatable on or about the axle 46. The tongue 32 is pivotably connected to the axle assembly 40 about a horizontal axis 48. Consequently, the tongue 32 is pivotable about both vertical axis 44 and horizontal axis 48.

The trailer 34 also includes a propulsion system 50, a brake system 52, a steering system 54, a tongue pivot system 56, and an electronic controller 58. In some instances, the trailer 34 also includes a light system 60. The propulsion system 50 is operable to cause the trailer 34 to move over a surface, such as ground 14. The propulsion system 50 may be similar to propulsion system 20. For example, in some implementations, the propulsion system 50 includes a motive device, such as an engine (e.g., an internal combustion engine), a motor (e.g., an electric motor), or another device configured to produce a motive force to propel the trailer 34 over a surface. In some implementations, the propulsion system 50 also includes an energy source, such as a fuel (e.g., a liquid fuel or gaseous fuel), one or more batteries, or another type of energy storage technology. The motive device utilizes the energy source to power the motive device and, consequently, move the trailer 34.

The trailer 34 also includes a brake system 52. Similar to the brake system 22, the brake system 52 may include, for example, a hydraulic system to pressurize and convey hydraulic fluid to one or more brake actuators (e.g., calipers, drum brakes, or other devices configured to apply a brake force) and rotors or other components configured to interact with the brake actuators to apply a brake force to the trailer 34. The brake system 34 is operable to alter a speed of the trailer 34, e.g., reduce a speed of the trailer, including stopping the trailer 34.

The steering system 54 is operable to pivot the axle assembly 40 about the vertical axis 44 by a desired amount in the rotary directions indicated by arrows 62 and 64, as shown in FIG. 3. The steering system 54 includes one or more actuators to pivot the axle assembly 40 and, consequently, the ground engaging components 35 attached thereto about the vertical axis 44. Example actuators include rotary actuators, linear actuators, electrical actuators, hydraulic actuators, electrical actuators, and mechanical actuators. Other types of actuators are also within the scope of the present disclosure, such as any actuator operable to pivot the axle assembly 40 about the vertical axis 44.

The tongue pivot system 56 is operable to pivot the tongue 32 about the horizontal axis 48 in the rotary directions indicated by arrows 66 and 68, as shown in FIG. 3. The tongue pivot system 56 includes one or more actuators to pivot the tongue 32 about the horizontal axis 48. Example actuators include rotary actuators, linear actuators, electrical actuators, hydraulic actuators, electrical actuators, and mechanical actuators. Other types of actuators are also within the scope of the present disclosure, such as any actuator operable to pivot the tongue 32 about the horizontal axis 48.

The light system 60 includes lights 70 and 72. Other lights or different lights may also be included. The lights 70 and 72 provide illumination at a desired location, e.g., at an area forward of the trailer 34, at an area rearward of the trailer 34, another area relative to the trailer, an area of the trailer, or a combination of these. In some instances, the light system 60 includes lights, such as marker lights used to provide a visual indication of the location of the trailer 34. In some instances, one or more of the lights of the light system 60, such as light 70 and 72, are movable. Further, in some implementations, operation of one or more lights of the light system (e.g., activation of one or more lights to produce illumination or deactivation of one or more lights to cease production of illumination), movement of one or more lights, or both may be performed automatically, such as in response to a signal from controller 58. Actuators, such as a type of actuator described earlier, can be used to alter a position of one or more lights of the light system 60.

The trailer 34 also includes a sensor system 74. The sensor system 34 includes one or more sensors 76, such as an image capture device, configured to sense a surroundings of the trailer 34. In some implementations, the sensor system 74 includes one or more image capture devices. Example image capture devices include cameras (e.g., optical or visual radiation cameras or red, green, blue (RGB) cameras), lidar, radar (e.g., long-range terahertz radar, frequency-modulated continuous wave radar (FMCW), ground penetrating radar), ultrasonic sensors, thermal sensors (e.g., thermal cameras), stereo cameras, laser vibrometers, infrared nuclear magnetic resonance (NMR) cameras, infrared short-wave infrared (SWIR) cameras, infrared terahertz sensors, other sensors operable to capture or generate an image representative of an area being imaged, e.g., an area of or adjacent to (e.g., forward or aft of) the trailer 34, or a combination of these. In the illustrated example of FIG. 2, the sensor 76 is positioned to image an area forward of the trailer 34. This area encompasses at least a portion of the tongue 32. For example, an image captured by the sensor 76 includes an entirety of the tongue 32. In some implementations, an image captured by the sensor 76 includes an entirety of the tongue; the axle assembly 40, the ground engaging components 35 attached to the axle assembly 40, or both; and at least a portion of the beam 39. Thus, in some implementations, the captured image includes the tongue 32 and another part of the trailer 34 to which the tongue is movable (e.g., pivotably movable) relative thereto. With this information, the controller 58 is operable to detect, for example, an angle of the tongue 32 relative to the beam 39 and a steering angle of the trailer 34.

The controller 58 is communicably connected, via either a wired or wireless connection, to the propulsion system 50, the brake system 52, steering system 54, the tongue pivot system 56, the light system 60, and the sensor system 74, and the controller 58 is operable to control operations of one or more or all of these connected systems. For example, in some implementations, the controller 58 utilizes the sensor 76 of the sensor system 74 to collect one or more images of an area. The controller 58 analyzes the one or more images to determine, for example, a proximity of the trailer 34 to a tow vehicle, such as combine harvester 2. If the controller 58 determines, for example, that the tow vehicle is present in the image, the controller 58 operates the propulsion system 50 to advance the trailer 34 towards the tow vehicle, as described in more detail below.

The controller 58 may also determine whether a target is present in the image. In some implementations, a target is, includes, or is part of a hitch on the tow vehicle, such as the hitch 30 of the combine harvester 2, shown in FIG. 1. Further, although the controller 58 is communicably connected to and is operable to receive output from the sensor system 74 and, particularly, sensor 76, in other implementations, the controller 58 is operable to receive input, such as sensor output, from one or more other sensors. One or more of those sensor may be located remotely from the trailer 34. For example, in some implementations, the controller 58 is communicably connected to sensor 21 provided on combine harvester 2, shown in FIG. 1. In other implementations, the controller 58 may be communicably connected to other remote sensors.

Where sensor 21 is an image capture device, the controller 58 can be configured to analyze the image output from the sensor 21 to, for example, detect whether the trailer 34 is present in a captured image, whether a target is present in a captured image, determine a route to move the trailer 34, combine harvester 2, or both, and signals to control one or more of the propulsion system 50, brake system 52, steering system 54, tongue pivot system 56, light system 60, or a combination of these of the trailer 34; the propulsion system 20, brake system 22, or steering system 13, of the combine harvester 2; or both to move the trailer 34, the combine harvester 2, or both according to the determined route. In some instances, determination of a route is omitted, and the controller 58 operates to control the various systems of the trailer 34, combine harvester 2, or both to position the trailer 34 and combine harvester 2 relative to each. That is, for example, the controller 58 may utilized one or more images to command the trailer 34, the combine harvester 2, or both to make incremental changes to the positions thereof. The controller 58 is operable to move one or both of the trailer 34 or the combine harvester 2 for the purpose of coupling the trailer 34 to the combine harvester 2. In some instances, coupling the trailer 34 and the combine harvester 2 involves connecting the hitch 30 of the combine harvester 2 to the tongue 32 of the trailer and, particularly, to a coupler 78 of the tongue 32 of the trailer 34. In some instances, the coupler 78 is provided at a distal end 80 of the tongue 38.

The trailer 34 also includes a first and second input device 82 and 84. Although two input devices 82 and 84 are shown, in other implementations, additional or fewer input devices may be included. The input devices 82 and 84 are operable to receive input from a user, such as an operator of a tow vehicle or another person, and output one or more signals to control one or more systems of the trailer 34. For example, in some instances, the input device 82 is configured to control operation of the propulsion system 20, the brake system 22, or both of the trailer 34 selectively, such as to move the trailer 34 in a forward direction indicated by arrow 86 and in a reverse direction indicated by arrow 88. In some implementations, movement of the trailer 34 in a particular direction continues for as long as the input device 82 remains activated. For example, in some implementations, the input device 82 may include one or more buttons or rocker switches, and depression of a button or rocker switch of the input device 82 sequentially causes the brake system 22 to release or remove a brake force and the propulsion system 20 to operate to move the trailer 34 in the forward direction of arrow 86. Similarly, in some implementations, depression of a button or rocker switch of the input device 82 sequentially causes the brake system 22 to release or remove a brake force and the propulsion system 20 to operate to move the trailer 34 in the rearward direction of arrow 88. Movement of the trailer 34 in the direction of arrow 86 or 88 continues for as long as the input device 82 remains engaged, e.g., for as long as a button or rocker switch remains depressed. Deactivation of the input device 82 stops the propulsion system 20 from moving the trailer 34 in the direction of arrow 86 or arrow 88 and operates the brake system 22 to reapply the brake force, thereby placing the trailer 34 in a static condition and in a condition to prevent further movement of the trailer 34. In the context of a button, release of the button, for example, causes the propulsion system 20 to stop movement of the trailer 34 in the direction of arrow 86 or arrow 88 and thereafter operate the brake system 22 to apply the brake force to maintain the trailer 34 in a stationary condition.

Input device 84 may be similar to input device 82 and include one or more input devices, such as one or more buttons or rockers switches. Input device 84 is configured to control operation of the steering system 54 and may operate in a manner similar to input device 82. For example, activation of the input device 84 causes operation of the steering system 54 to pivot the axle assembly 40 about the vertical axis 44. In some implementations, operation of the steering system 54 continues for so long as the input device remains activated, e.g., for so long as a button or rocker switch remains depressed. Deactivation of the input device 84, e.g., release of a button or rocker switch, ceases operation of the steering system 54. In some instances, the input device 84 includes an input device that is operable to receive different inputs for a turn in the direction of arrow 62 or a turn in the direction of arrow 64. Thus, an operator, via interaction with the input device 84, is able to control a direction of rotation of the steering system 54 to control a direction of rotation of the axle assembly 40 about the vertical axis 44 and, thus, a steering angle of the trailer 34 and an orientation of the tongue 32.

In some instances, the trailer 34 also includes a third input device 90. The input device 90 may be similar to input devices 82 and 84 and is configured to operate the togue pivot system 56 in a manner similar to that described earlier. For example, the input device 90, when actuated, is configured to operate the tongue pivot system 56 for so long as the input device 90 remains activated. Deactivation of the input device 90 ceases operation of the tongue pivot system 56. Thus, in an implementation where the input device 90 is or includes a button, depression of the button causes operation of the tongue pivot system 56 until the button is released, thereby cause the tongue pivot system 56 to cease operation. In some implementations, similar to input device 86, the input device 90 includes functionality that interaction with the input device 90 in a first manner causes rotation of the tongue in the direction of arrow 66 while interaction with the input device in a second manner causes rotation of the tone in the direction of arrow 68. For example, the input device 90 may include a separate button for operating the tongue pivot system 56 to rotate the tongue 32 in the different directions. Similarly, a rocker switch may be used where rotation of the rocker switch in one direction causes rotation of the tongue 32 in one of the direction (e.g., the direction indicated by arrow 66) and rotation of the rocker switch in a second direction, opposite the first direction, causes rotation of the tongue 32 in the opposite direction (e.g., the direction indicated by the arrow 68).

Although one or more buttons or rocker switches are described in the context of input device 82, other types of input devices may be included and are within the scope of the present disclosure, whether in the context of the first input device 82, the second input device 84, the third input device 90, or other input devices. For example, in some implementations, other input devices may include joysticks, sliders, touchscreens, or dials.

Although manual operation of the of trailer 34 using input devices 82, 84, and 90 is described, the scope is not so limited. Rather, a header, such as header 400, shown in FIG. 4 and described in more detail below, may be operated in a similar manner using input devices, whether provided on the header or provided remotely from the header.

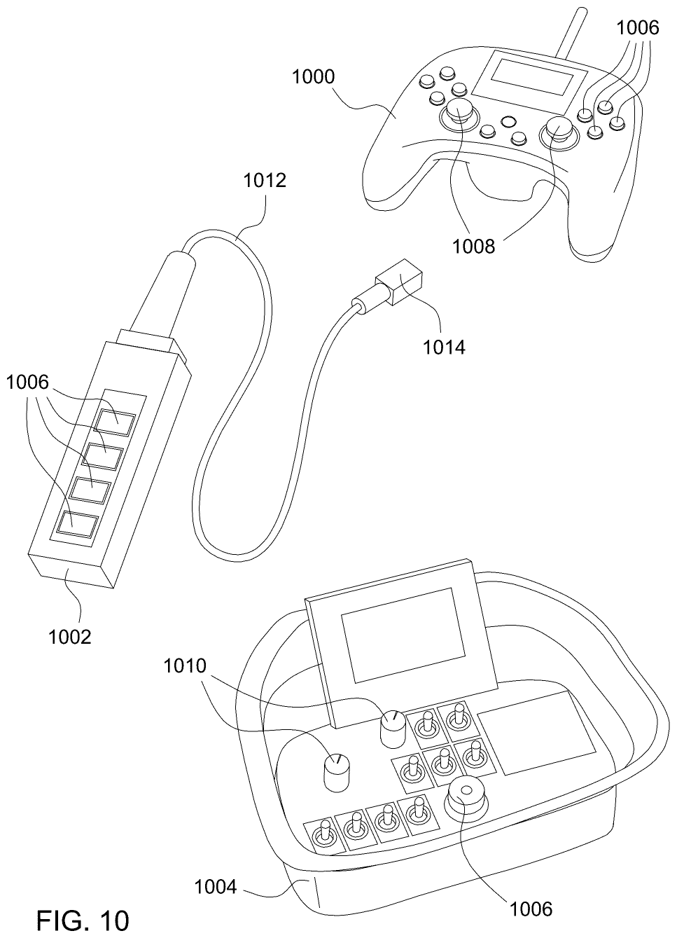

Further, although the example described includes input devices provided on the trailer 34, in other implementations, one or more of the input devices can be located remotely from the trailer 34. Remotely located input devices may be communicably coupled to the trailer 34, sch as via a wired or wireless connection. Example types of remote-control devices having one or more input devices are shown in FIG. 10.

As shown in FIG. 2, the input device 82 is located or is connectable at a position on the trailer 34 such that an operator operating the input device 82 is able to see directly a portion of the hitch 30 that engages the tongue 32 (or other part of the trailer 34) that connects with the hitch 30. This visibility provided to the operator allows the operator to see a position of the hitch 30 relative to the tongue 32 as the operator controls movement, via operation of the propulsion system 20, of the trailer 34 with the input device 82, as described herein. With this visibility, the operator is able to interact with the input device 82 to control movements of the trailer 34 to couple the combine harvester 2 with the trailer 34. Movement control of the trailer 34 in this way includes forward and backward movement and, in some instances, lateral alignment, of the trailer 34 relative to the combine harvester 2 or another tow vehicle. Thus, in some implementations, lateral alignment is controlled with input device 84 to operate the steering system 54 for controlling a lateral position of the trailer 34. This control also includes the ability to stop the trailer 34 as desired by the operator, such as by activation and deactivation (e.g., release) of the brake system 22.

FIG. 10 shows a variety of example handheld remote-control devices 1000, 1002, and 1004, and one or more of these example handheld remote-control devices includes one or more input devices that are operable to control operation of one or more of a control various systems of header or agricultural header transport system, such as a propulsion system, a brake system, and a steering system thereby controlling movement and operation of the header or header or agricultural header transport system. Examples of input devices included on a remote-control device include one or more buttons, joysticks, sliders, touchscreens, dials, knobs, or other input devices. These one or more input devices may be used to provide input for controlling one or more systems on a header or agricultural into the propulsion input device 38. Particularly, in illustrated remote-control devices 1000, 1002, and 1004 include one or more buttons 1006, joysticks 1008, or dials 1010. Other implementations may include other types of input devices. The example remote control devices 1000 and 1004 are wireless devices, whereas the remote-control device 1006 is a wired device and includes an electrical cord 1012 and connector 1014 to connect to a header or agricultural header transport system. Thus, example remote-control devices within the scope of the present disclosure includes physically tethered and physically untethered electronic devices. In some instances, the input devices for controlling operation of a header or agricultural header transport system, as described herein, may be provided on a personal communication device, such as a smartphone.

Thus, in some implementations, control of one or more systems of the tailer 34 is performed automatically in response to control of the controller 58, while, in other implementations, control of one or more systems of the trailer is performed manually. Further, although controller 58 is shown as being included with the trailer 34, in other implementations, the controller 58 may be partially located on the trailer, partially located on the tow vehicle, entirely located on the tow vehicle, partially located remotely at another location or a plurality of other locations, or entirely located remotely at another location or a plurality of other locations.

FIG. 4 is a side view of an example header 400 within the scope of the present disclosure. The header 400 may be any type of agricultural header, such as a corn header, a draper header, a pickup header, or another type of header or implement. The header 400 includes a mount 402 configured to connect the header 400 to a harvester, such as to a feederhouse of a combine harvester. The header 400 also includes ground engaging components 404. In some implementations, the ground engaging components 404 are wheels, e.g., wheel and tire assemblies. In some implementations, the ground engaging components 404 are retractable into a retracted position, which may be used when being connected to a harvester and being used to perform an agricultural operation, and an extended position, such as when the header 404 is being transported from one location to another. The ground engaging components 404 are operable to convey the header 404 over a surface 406, such as the ground 406. The header 400 includes a ground engaging components system 404 that is operable to extend and retract the ground engaging components between the retracted position and the extended position. The ground engaging component system 404 may include one or more actuators 410, such as one or more of the types of actuators described herein, to move the ground engaging components between the extended position and the retracted position. For example, in some implementations, the actuators 410 are operable to pivot arms 412 about axes 414 to move the ground engaging components 404 coupled to the arms 412 between the retracted and extended positions.

Similar to the trailer 34, the header 400, shown in FIG. 4, includes a propulsion system 416, a brake system 418, a steering system 420, a tongue pivot system 422, a light system 424, and an electronic controller 425. Each of these systems operates in a manner similar to that described above with respect to the trailer 34. For example, the propulsion system 416 includes one or more of an engine (e.g., an internal combustion engine), a motor, an energy source (e.g., a liquid fuel or electrical energy source or storage device, e.g., one or more batteries), a transmission, and a drive system (e.g., one or more shafts, belts, or other power transmission components). In some implementations, the transmission is operable to cause the propulsion system to operate in a first configuration (so as to cause movement in a first direction, e.g., a forward direction) or a second configuration (so as to cause movement in a second direction, e.g., a reverse direction) in response to an input received from a propulsion input device.

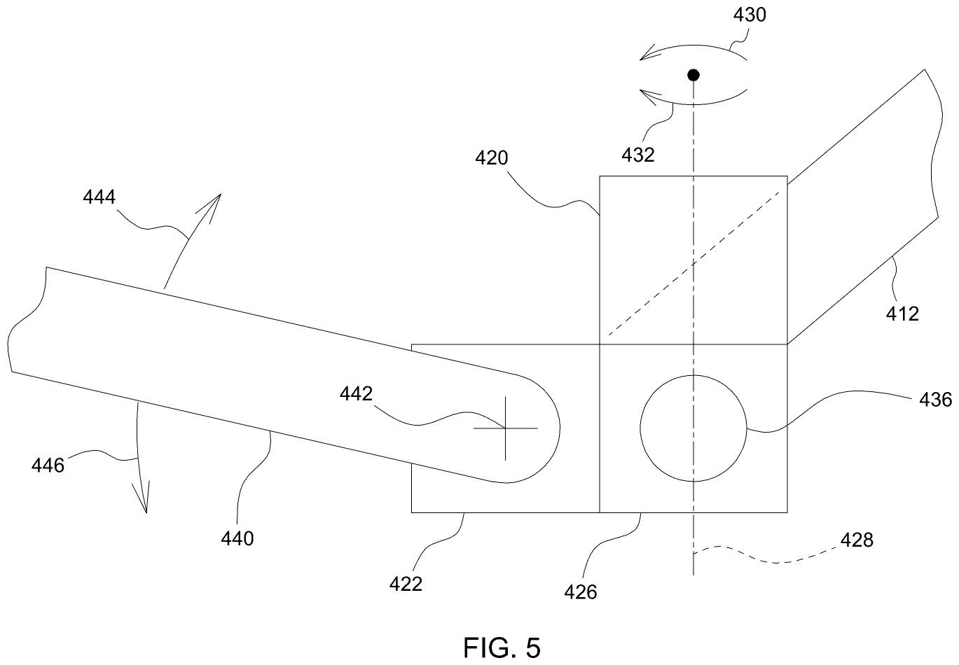

The steering system 420 is operable to pivot an axle assembly 426 about the vertical axis 428 by a desired amount in the rotary directions indicated by arrows 430 and 432, as shown in FIG. 5. The steering system 420 includes one or more actuators to pivot the axle assembly 426 and, consequently, the ground engaging components 404 attached thereto about the vertical axis 428. The ground engaging components 404 at a forward end 434 of the header 400 is rotatably connected to an axle 436 included on the axle assembly 426. Example actuators include rotary actuators, linear actuators, electrical actuators, hydraulic actuators, electrical actuators, and mechanical actuators. Other types of actuators are also within the scope of the present disclosure, such as any actuator operable to pivot the axle assembly 426 about the vertical axis 44.

In some implementations, the tongue pivot system 422 is similar to tongue pivot system 56. The tongue pivot system 422 is operable to pivot a tongue 440 of the header 400 about the horizontal axis 442 in the rotary directions indicated by arrows 444 and 446, as shown in FIG. 5. The tongue pivot system 422 includes one or more actuators to pivot the tongue 440 about the horizontal axis 442. Example actuators include rotary actuators, linear actuators, electrical actuators, hydraulic actuators, electrical actuators, and mechanical actuators. Other types of actuators are also within the scope of the present disclosure, such as any actuator operable to pivot the tongue 440 about the horizontal axis 442.

The light system 424 includes lights 448 and 450. Other lights may also be included. The lights 448 and 450 provide illumination at a desired location, e.g., at an area forward of the trailer 34, at an area rearward of the header 400, another area relative to the trailer, and area of the trailer, or a combination of these. In some instances, the light system 424 includes lights, such as marker lights used to provide a visual indication of the location of the header 400. In some instances, one or more of the lights of the light system 424, such as light 448 and 450, are movable. Further, in some implementations, operation of one or more lights of the light system (e.g., activation of one or more lights to produce illumination or deactivation of one or more lights to cease production of illumination), movement of one or more lights, or both may be performed automatically, such as in response to a signal from controller 425. Actuators, such as a type of actuator described earlier, can be used to alter a position of one or more lights of the light system 424.

The header 400 also includes a sensor system 452 similar to the sensor system 74. The sensory system includes one or more sensors 454, such as one or more image capture devices. The one or more sensors 454 may be similar to the one or more sensors 76 and be of a type described earlier. The sensor system 452 operates similarly to sensor system 74.

The brake system 418 may be similar to the brake system 52, described earlier. Further, operation and control of the brake system 418 may be similar to the operation and control of the brake system 52 described earlier.

The controller 425 is communicably connected, via either a wired or wireless connection, to the propulsion system 416, the brake system 418, steering system 420, the tongue pivot system 422, the light system 424, and the sensor system 452, and the controller 425 is operable to control operations of one or more or all of these connected systems, as described above in the context of trailer 34. Thus, in some implementations, the controller 425 of the header 400 operates similarly to the controller 58 to maneuver the header 400, a tow vehicle, or both relative to each other for the purpose of connecting the header 400 and the tow vehicle together, as described above. Further, the explanation of the controller 58, including operation thereof, is applicable to the controller 425. For example, the controller 425 is operable to receive one or more images (e.g., one or more images of one or more areas adjacent to the header 400) output from one or more image sensors, such as one or more images from sensor 454, and control, for example, operation of the propulsion system 416, the brake system 418, the steering system 420, the tongue pivot system 422, and the light system 424 to connect the header 400 to the tow vehicle, as described herein, for example, in the context of the trailer 34. Similar to controller 58, the controller 425 is operable to detect one or more targets in the images, the tongue 440 of the header 400, or both, to guide the header 400, the tongue 440, the tow vehicle, or a combination of these to effectuate coupling of the header 400 to the tow vehicle. Consequently, the controller 425 includes the functionality described above to control these various systems move the header 400, a tow vehicle (such as a combine harvester), or both relative to each other to effectuate coupling of the header 400 and the tow vehicle together.

The header 400 also includes input devices 456, 458, and 460 which may be similar to input device 82, 84, and 90. Further, the input devices 456, 458, and 460 are operable in a manner similar to input device 82, 84, and 90. Consequently, input device 456, 458, and 460 are operable to control the header 400 in a manner similar to that input device 82, 84, and 90 are used to control trailer 34. Thus, the explanation of input device 82, 84, and 90, including operation thereof and the results of operation thereof, is applicable to the input device 456, 458, and 460. Accordingly, that earlier explanation being applicable, further explanation of the input devices 456, 458, and 460 is omitted.

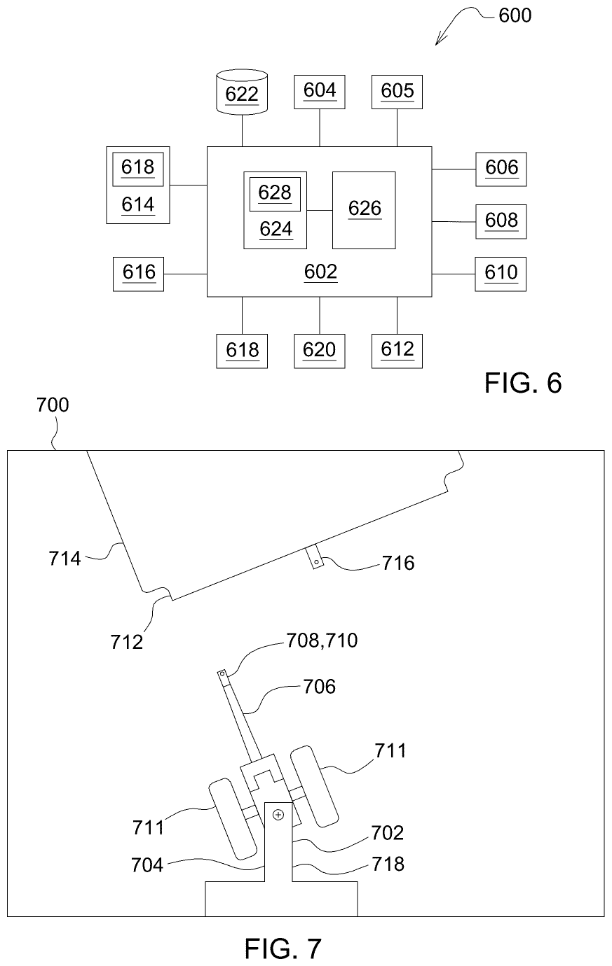

FIG. 6 is a schematic view of an example control system 600 for controlling movement of a header or header transport system (collectively and interchangeably referred to herein as an agricultural machine) in response to operation of one or more input devices; automatically controlling movement of a trailer or header, a tow vehicle, or a combination thereof in response to image output from one or more sensors, as described here; or both.

The control system 600 may be similar to the controller 25, controller 58, or controller 425 and operate as described above with respect thereto. The control system 600 includes an electronic controller 602, which may be similar to controller 25, controller 58, or controller 425. The controller 602 may be a computer or computer system, such as computer 1302 or computer system 1300. The control system 600 also includes a propulsion system 604 (which may be similar to propulsion system 20, 50, or 416), a brake system 605 (which may be similar to brake system 22, 52, or 418), a steering system 606 (which may be similar to steering system 13, 54, or 420), and a tongue pivot system 608 (which may be similar to tongue pivot system 56 or 422), a light system 610 (which may be similar to light system 60 or 424), and a sensor system 612 (which may be similar to sensor system 74 or 452). The control system 600 also includes a display 614, input devices 616, 618, and 620 (which may be similar to input devices 82, 84, 90, 456, 458, or 460), and a database 622. Additional or fewer input devices may be included. In some implementations, the display 614 and the database 622 may be omitted. In some instances, the database 622 is a memory storage device that stores information used or associated with the controller 400. In some instances, the database 414 may store other types of information, such as information related to an agricultural header transport system or a header more generally. In some instances, the database 414 stores identification information associated with a variety of different types of headers or agricultural header transport systems, including manufacturer, model type, and other types of information. For example, other types of information may include tongue length, a range of movement that the tongue is able to pivot about a vertical axis (e.g., an amount of rotation that the tongue is able to undertake relative to another portion of the header or agricultural header transport system), vehicle width, vehicle height, a range of motion that a tongue is able to pivot about a horizontal axis, or other types of information. The database 414 may also store information, including information similar to that described above, regarding different types of tow vehicles. The database 622 may be located remotely.

The display 614 is operable to display information related to operation of the control system 600, such as information related to the propulsion system 604, the brake system 604, steering system 606 or other information. For example, the display 614 may display whether the one or more of the communicably coupled systems is being operated and, if so, the details associated with that operation, or whether the sensory system 612 is presently collecting data, such as collecting one or more images. In some implementations, the display 614 is configured to display one or more of the captured images. In some instances, the information displayed by the display 614 is displayed via a graphical user interface (GUI) 618. Example graphical user interfaces are described in more detail below. In some implementations, the display 614 is a touch screen that is operable to receive input from a user via a user's touch.

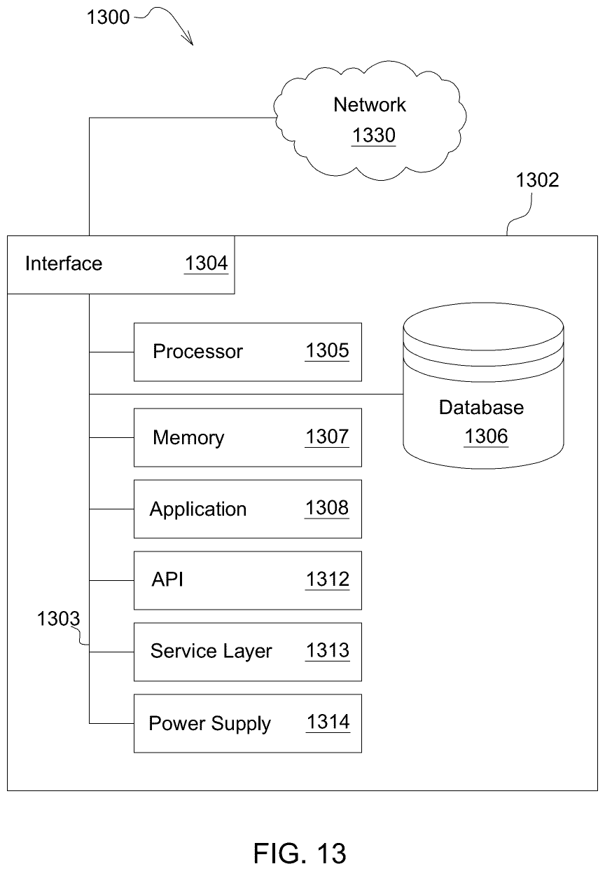

The controller 602 includes a processor 624 and a memory 626 communicably coupled to the processor 624. Additional details of the controller 602, such as processor 624 and memory 626, are described below in the context of computer 1302. In some implementations, the controller 602 is communicably coupled with a network, such as in a manner described in more detail below in the context of FIG. 13. The memory 626 communicates with the processor 624 and is used to store programs and other software, information, and data. The processor 624 is operable to execute programs and software and receive information from and send information to the memory 626. Although a single memory 626 and a single processor 624 are illustrated, in other implementations, a plurality of memories, processors, or both may be used. Although the processor 624 and the memory 626 are shown as being local components of the controller 602, in other implementations, one or both of the processor 624 and memory 626 may be located remotely. The various components of the control system 600 are communicably coupled to the controller 602, such as via a wired or wireless connection.

Software 628, such as in the form of an application or program, is executed by the processor 624 to control operation of the control system 600, as described herein. Particularly, the software 628 includes executable instructions operable to control operation of the various components communicably coupled to the controller 602 and, as a result, control movement of an agricultural header transport system, a header, a combine harvester, or a combination thereof, such as by controlling operation of the propulsion system 604, the brake system 605, the steering system 606, the tongue pivot system 608, the light system 610, the sensor system 612, or a combination thereof. For example, the software 628 includes instructions to cause the processor 624 to perform example methods 1100 and 1200, described in more detail below.

For example, the software 628 may operate as described in the context of FIGS. 7, 8, and 9. FIG. 7 is an example image 700 collected by an image sensor, such as image sensor 21, 76, or 454. The image 700 shows a forward end portion 702 of an agricultural header transport system 704, which may be similar to trailer 34. Although an agricultural header transport system 704 is shown, the present explanation would be equally applicable to a header, such as header 400. The image 700 also shows a tongue 706 connected to the forward end portion 702 of the agricultural header transport system 704 and a coupler 708 provided on a distal end 710 of the tongue 706. Ground engaging components 711 of the agricultural header transport system 704, which may be similar to ground engaging components 35, are also shown in image 700. The image 700 also shows an aft portion 712 of a tow vehicle 714, which may be similar to combine harvester 2. The aft portion 708 of the tow vehicle 710 includes a hitch 716.

Using, e.g., executing, software, such as software 628, a controller (such as controller 25, controller 58, or controller 425) receives the image data and, in some implementations, detects the tongue 706, a portion 718 of the agricultural header transport system 704 to which the tongue 706 is pivotably connected, and the hitch 716, which may be considered a target. In some implementations, the controller also identifies the coupler 708. In some implementations, the controller identifies the various objects using, for example, object detection, artificial intelligence, including machine learning, or both. Example types of object detection include one or more of the following image analysis techniques: two-dimensional (2D) object recognition, three-dimensional (3D) object recognition, image segmentation, motion detection (e.g., single particle tracking), video tracking, optical flow, 3D pose estimation, pattern recognition, and object recognition, to name a few. These example image analysis techniques are not exclusive. Thus, other types of image analysis techniques may be employed to detect the various items within an image as well as movement of those items between images. Example types of artificial intelligence that can be used to identify objects or classify detected objects include, but are not limited to, supervised learning algorithms, unsupervised learning algorithms, semi-supervised learning algorithms, and reinforcement learning algorithms. In some implementations, neural networks, including neural networks using deep learning, may also be used to identify objects in the image data. Example neural networks include perception neural networks, Feed-forward neural networks, convolutional neural networks, recurrent neural networks, and autoencoders, to name only a few. Other types of neural networks are also within the scope of the present disclosure.

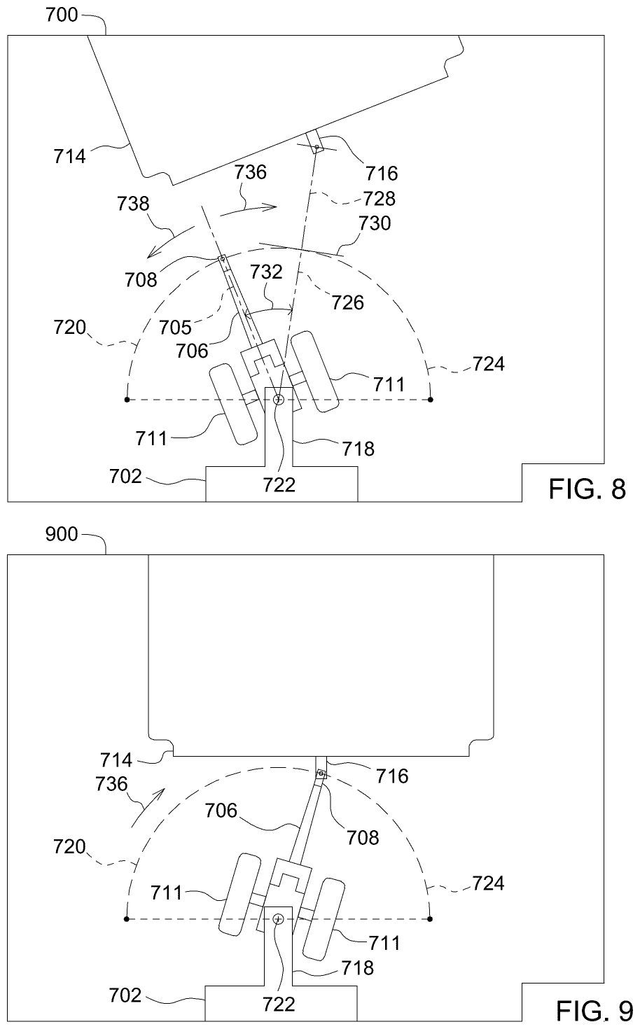

With reference to FIG. 8, using the identified tongue 706 and the portion 718 of the agricultural header transport system 702 to which the tongue 706 is pivotably coupled, the controller is configured to identify a movement profile 720 of the tongue relative to the portion 718. That is, the controller is operable to determine a range of motion that the tongue 706 is capable of moving relative to the portion 718. In some implementations, the controller utilizes information in a database, as described herein, to determine a range of motion of the tongue 706 relative to the portion 718. The movement profile 720 represents a plurality of available movements of the tongue 706 relative to the portion 718 about a vertical axis 722. With the movement profile 720 identified, the controller is operable to generate a curve 724 that represents how a location along the tongue 706 moves based on the movement profile 720. In the illustrated example, the curve 724 represents how the coupler 708 moves as the tongue 706 is pivoted about the vertical axis 722.

As shown in FIG. 8, a line 726 extends between the vertical axis 722 and the hitch 716. A gap 728 exists along the line 726 between the hitch 716 and a line 730 that is tangent to the curve 724 where the line 726 intersects the curve 724. This description is provided merely as an example, and the gap 728 between the curve 722 and the hitch 716 may be determined in a variety of other ways, which are also within the scope of the present disclosure. An angle 732 formed between a line 705 extending along the tongue 706 (e.g., a centerline of the tongue) and the line 726 is also determined.

Using the gap 728 and the angle 732, the controller is operable to operate a steering system, a brake system, and a propulsion system of the agricultural header transport system 702 to maneuver the agricultural header transport system 702 towards the hitch 716 of the tow vehicle 714. The controller may also utilize output from another sensor, such as an image capture sensor, a distance or proximity sensor, or another sensor or sensors that senses a vertical distance between the coupler 708 and the hitch 716. In this way, the controller is also configured to operate a tongue pivot system of the agricultural header transport system 702. For example, the controller operates the tongue pivot system to increase a vertical height of the coupler 708 a selected distance above the hitch.

FIG. 9 is another image 900 that shows that the agricultural header transport system 702 has advanced towards the tow vehicle 714 and that the tongue 706 has rotated about the vertical axis 722 in the direction of arrow 736 such that the coupler 708 is shown to overlay the hitch 716. In this position, the controller can control the tongue pivot system to lower the coupler 708 onto the hitch 716.

The steering system, the brake system, and the propulsion system may be controlled over a period of time represented by a series of images captured by one or more image capture devices. Using the different images, the controller can make changes to operation of the propulsion system, brake system, and steering system to control the movement of the agricultural header transport system 702 to ensure coupling of the agricultural header transport system 702 to the tow vehicle 714. These various systems may be similar to counterpart systems already described herein. For example, analysis of each image by the controller may cause the controller to alter operation of one or more of these systems to ensure alignment of the coupler 708 with the hitch 716.

In the illustrated example, moving from image 700 to image 900, the controller utilizes the images 700 and 900 to actuate the steering system to turn an axle assembly 734, which may be similar to axle assembly 40 or 426, by a selected amount in the direction of arrow 736. For example, the controller may operate the steering system to rotate the axle assembly 734 in the amount of angle 732. Additionally, the controller may also activate the propulsion system to advance the agricultural header transport system 702 towards the tow vehicle 714 and, particularly, towards the hitch 716. As the agricultural header transport system 702 moves towards the hitch 716, a further change to a position of the axle assembly 734 may be needed in order to align the coupler 708 with the hitch. Thus, using, for example, one or more additional images, the controller may operate the steering system to adjust a rotational position of the axle assembly 734 in the direction of arrow 736 or a direction of arrow 738. Further, the controller may also operate the brake system to slow or stop the agricultural header transport system 702, for example to capture another image for further processing (e.g., to utilize to make additional operations of one or more systems of the agricultural header transport system 702); operate the propulsion system, such as to move the agricultural header transport system 702 forward, closer to the tow vehicle 714, or reverse the agricultural header transport system 702, such as to improve a position of the agricultural header transport system 702; alter a steering angle axle assembly 734 to better position the tongue 706 for coupling with the hitch 716, or alter a position or configuration of the agricultural header transport system 702 in another way; operate another system; or a combination of these.

The controller may also control other systems, such as a light system of the agricultural header transport system 702, a light system of the tow vehicle 714, or both to illuminate an area that may include one or more parts of the agricultural header transport system 702, the tow vehicle 714, or both. Further, although the control, by the controller, of the agricultural header transport system 702 is described, in other implementations, the controller may control movement of the tow vehicle 714 or control of movement of both the tow vehicle 714 and the agricultural header transport system 702. In some instances, one or more of the images, e.g., images 700 and 900, may be displayed to a user, such as an operator of the tow vehicle, on a display, such as display 614.

In some implementations, other sensors may be used to provide additional information to facilitate coupling of the agricultural header transport system 702 to the tow vehicle 714. For example, a distance sensor, such as a radar, lidar, laser sensor, or proximity sensor may be used to detect a distance between the agricultural header transport system 702 and the tow vehicle 714. This information may be used to alter a position of the tongue 706, for example. The controller may utilize this distance information to alter operation of one or more systems of the agricultural header transport system 702 to facilitate maneuvering of the agricultural header transport system 702 and coupling of the agricultural header transport system 702 to the tow vehicle 714.

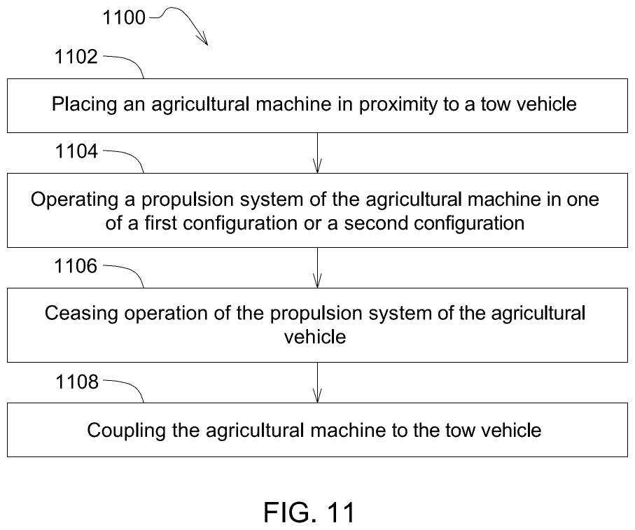

FIG. 11 is a flowchart of an example method 1100 of controlling movement of an agricultural header or an agricultural header transport system, which may be collectively referred to as an agricultural machine. Controlling movement of the agricultural machine is performed, for example, for the purpose of connecting the agricultural machine to a tow vehicle for transporting the agricultural machine to another location. Control of the movement of the agricultural machine may be performed manually or automatically as described herein, for example.

At 1102, an agricultural machine is placed in proximity to a tow vehicle, such as an agricultural harvester or another vehicle operable to move the agricultural machine from one location to another. A proximity to the tow vehicle includes, for example, a location aft of the tow vehicle or a location from which the agricultural machine can be guided, either manually or automatically, to a location relative to a tow vehicle at which the agricultural machine and the tow vehicle can be coupled together. At 1104, a propulsion system of the agricultural machine is operated in one of a first configuration or a second configuration. In some instances, operation of the propulsion system is activated in response to input received from an input device. In some instances, operational control is may by an electronic controller. When operated in a first configuration, the propulsion system moves the agricultural machine in a first direction, such as a forward direction. When operated in a second configuration, the propulsion system moves the agricultural machine is a second direction, such as a reverse direction. Further, in some implementations, operation of the propulsion system drives one or more ground engaging components, e.g., wheels or tracks, to move the agricultural machine over a surface, such as the ground. At 1106, operation of the propulsion system is ceased. Operation of the propulsion system may cease in response to another input received by the input device. At 1108, the agricultural machine is coupled to the tow vehicle. For example, a first coupler, e.g., a coupler provided on a tongue, on the agricultural machine is connected with a second coupler, e.g., a hitch, provided on the tow vehicle.

In some implementations, other systems may be operated in moving the agricultural machine for coupling to the tow vehicle. For example, in some instances, a brake system may be operated to cease movement of the agricultural machine. For example, the agricultural machine may be located on a sloped surface, and deactivation of the propulsion system may not prevent further movement of the agricultural machine. Thus, operation of the brake system may be performed to ensure movement of the agricultural machine ceases. In some implementation, ceasing operation of the propulsion system automatically initiates activation of a brake system to apply a brake force to cease movement of the agricultural machine over the surface. Additionally, coupling the first and second couplers together may involve actuation of a steering system, a tongue pivot system, or both to maneuver the first and second couplers into locations relative to each other to facilitate coupling. Operating the steering system alters a steering angle and, thus, a configuration of the agricultural machine. For example, altering a steering angle by the steering system alters a configuration of one or more ground engaging components. Alteration to the configuration of the ground engaging components operates to change a direction of travel of the agricultural machine, such as when the propulsion system operates to move the agricultural machine. Further, a motive device of the propulsion system operates to drive at least one ground engaging component of the agricultural machine to drive the agricultural machine over a surface.

In some implementations, operation of one or more systems, such as the propulsion system or steering system, continues for as long as an input device receives an input, such as an input by a user. Examples in the context of the trailer 34 and, particularly, use of input devices 82, 84, and 90 and in the context of header 400 and, particularly, use of input devices 456, 458, and 460 illustrate how operation of a system may continue while an input is being applied to an input device and operation cease when the applied input is ceased.

In some implementations, operation of one or more systems of the agricultural machine may be performed automatically based on sensor output, such as one or more images captured by one or more image capture devices, as described herein.

In some implementations, operation of the propulsion system or another system of the agricultural machine may be selectively operated to position the agricultural machine relative to the tow vehicle. For example, operation of the propulsion system may be activated and deactivated a plurality of times with an evaluation between each operation of the propulsion system. For example, an evaluation may be manually performed, such as by a user, or automatically performed, such as with a controller, as described herein. At each evaluation, a change to operation of one or more systems may be performed. For example, after the agricultural machine has been moved a distance towards the tow vehicle, an evaluation may determine that an orientation of the agricultural machine or a tongue of the agricultural machine should be altered. An evaluation may utilize one or more images captured after a prior movement. Thus, in response to the evaluation, a steering system may be operated to alter a steering angle of the agricultural machine, a tongue pivot system of the agricultural machine may be operated to alter a pivot amount of the tongue, a light system of the agricultural machine may be operated to alter an amount of illumination at a location, or a change to another system may be needed. In some implementations, one or more alterations by operation of one or more systems may be performed at one evaluation period or sequentially at different evaluation periods. In some instances, after each change, the propulsion system is operated again for a period of time. For example, if, based on an evaluation, a steering system was operated to adjust a steering angle of the agricultural machine, the propulsion system of the agricultural machine is operated again to move the agricultural machine closer to the tow vehicle. With the change to the steering angle and the subsequent operation of the propulsion system, an orientation and distance relative to the tow vehicle is altered. This alteration is to improve positioning of the agricultural machine to the tow vehicle to facilitate coupling of the agricultural machine to the tow vehicle. In some instances, a plurality of evaluations are made at selected intervals associated with movement of the agricultural machine, the tow vehicle, or both.

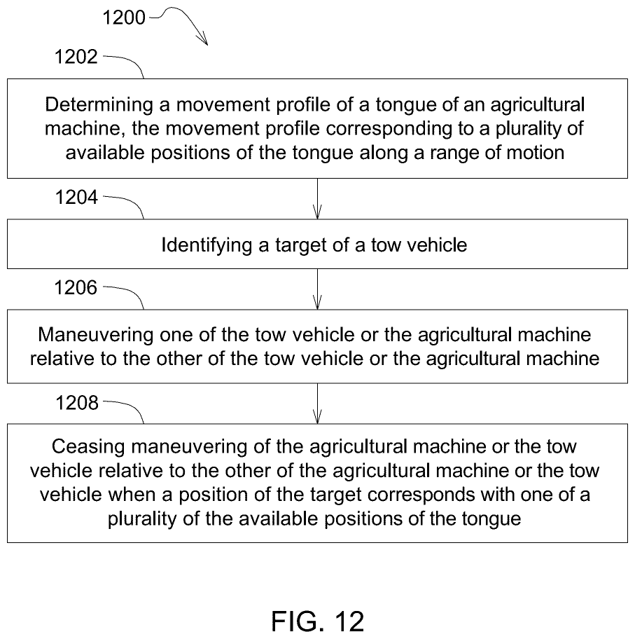

FIG. 12 is flowchart of another example method 1200 for aligning an agricultural machine with a tow vehicle for connecting of the agricultural machine and the tow vehicle. In some implementations, method 1200 is performed as commanded by a controller according to programming instructions. At 1202, a movement profile of a tongue of the agricultural machine is determined. The movement profile corresponds to a plurality of available positions of the tongue along a range of motion. In some implementations, the movement profile is determined with one or more processors (such as processor 1305), and, in some instances, the one or more processors utilize output from one or more sensors (e.g., one or more images captured by one or more image capture devices). In some implementations, the one or more processors are or form part of an electronic controller. In some implementations, the electronic controller is or includes a computer, such as computer 1302, or a computer system, such as computer system 1300. Additionally, in some instances, the one or more processors utilize object detection, machine learning, or both to identify a tongue of the agricultural machine. In some instances, the one or more processors operate to identify another portion of the agricultural machine. Similarly, in some implementations, object detection, machine learning, or both is used to detect the other portion of the agricultural machine. In some implementations, the one or more processors identify another portion of the agricultural machine to which the tongue is movable (e.g., pivotable) relative thereto. In some instances, the one or more processors determines a range of motion of the tongue relative to the other portion of the agricultural machine. Further, in some instances, a curve is generated corresponding to locations of the coupler along the movement profile of the tongue. At 1204, a target of a tow vehicle is identified. In some instances, the target is a hitch of the tow vehicle. The hitch may be identified with one or more processors using, for example, sensor output as described earlier. For example, one or more images captured by one or more image capture devices are used to identify the hitch. Further, in some instances, the one or more processors use object recognition, machine learning, or both to identify the target of the tow vehicle in the one or more images.

At 1206, one of the tow vehicle or the agricultural machine is maneuvered relative to the other of the tow vehicle or the agricultural machine. In some instances, both the tow vehicle and the agricultural machine are maneuvered relative to each other. In some implementations, maneuvering the tow vehicle or the agricultural machine is maneuvered by operation of one or more of a propulsion system, a steering system, or a brake system of the agricultural machine or the tow vehicle. At 1208, maneuvering of the agricultural machine or the tow vehicle relative to the other of the agricultural machine or the tow vehicle is ceased when a position of the target corresponds with one of a plurality of the available positions of the tongue. In some implementations, movement of the tow vehicle, the agricultural machine, or both ceases when a position of the target, e.g., hitch, corresponds with one of the plurality of available positions of the tongue, such as a one of the plurality of available positions along the curve.

In some instances, altering a position of the tongue along the range of motion to cause a position of a coupler provided on the tongue to corresponds to the position of the target. In some instances, a position of the tongue is altered with operation of one of the steering system of the agricultural machine, a propulsion system of the agricultural machine, a tongue pivot system of the agricultural machine, or a combination of these. Altering a position of the tongue along the range of motion to cause a coupler provided on the tongue to correspond to the position of the target may include actuating an actuator to move the tongue to a position of the target, determining when the position of the coupler on the tongue corresponds to the target, and ceasing operation of the actuator. Further, an electronic controller is operable to control operation of the actuator and determine when a position of the coupler corresponds to a position of the target. The method 1200 may also include coupling the coupler on the tongue to a target, which, in some instances, is a hitch of the tow vehicle. Further, a vertical position of the coupler on the tongue may be altered by operating a tongue pivot system to facilitate coupling of the coupler to the hitch.

In some implementations, one or more sensors are configured to detect a location of the agricultural machine. In some implementations, a global navigation satellite system (GNSS), such as the Global Positioning System (GPS), one or more images, a recorded location at which the agricultural machine placed on the ground, or a combination of these may be used to determine a location of the agricultural machine. For example, where the agricultural machine is an agricultural header, a location where the header was detached from a harvester (e.g., a combine harvester) and left on the ground may be recorded in a memory device, such as the database 622. Further, a location of the tow vehicle may similarly be detected using one or more sensors, such as those described above, or a recorded location. In some instances, an electronic controller can use the output of one or more of these sensors to make these determinations automatically and to control movement of the agricultural machine or the tow vehicle towards the other of the agricultural machine or tow vehicle or both using the determined information. Maneuvering the agricultural machine, the tow vehicle, or both also include operating a brake system respectively thereof to cease movement thereof, such as when the position of the coupler corresponds to the position of the hitch.

In other implementations, other types of information may be stored for use by a controller, such as controller 58. In some instances, memory, such as memory 626, or a database, such as database 622, store details for one or more agricultural machines, including agricultural header transport systems, such as the trailer 34, or headers, such as the header 400. The stored information may include make, model, dimensions, configurations (e.g., an amount of rotation of the tongue 32 relative to beam 39), other information, or a combination thereof. A controller can be configured to utilize this information, for example, when a type of agricultural machine identified is identified in a captured image. In other instances, this information is associated with the agricultural machine on which the controller is located. As such, the controller utilizes this information when determining movements of the agricultural machine, articulating a tongue of the agricultural machine, generating a movement profile of the tongue, or defining a curve associated with the movement profile.

The methods 1100 and 1200 are not limited to the various listed features. Rather, additional, fewer, or different features may be included in the methods 1100 and 1200, and the methods 1100 and 1200 remain within the scope of the present disclosure. Various modifications, for example, the various modification described herein, may also be included. Further, an order of the various features of the methods 1100 and 1200 may be rearranged, while the methods 1100 and 1200 still remaining within the scope of the present disclosure.

Without in any way limiting the scope, interpretation, or application of the claims appearing below, a technical effect of one or more of the example implementations disclosed herein is reduce costs (e.g., labor costs) and complexity associated with connecting an agricultural header or agricultural header transport system to a tow vehicle to facilitate movement of the agricultural header or agricultural header transport system to another location. Another technical effect of one or more of the example implementations disclosed herein is increased agricultural operational efficiency. By reducing time to move a header from one location to another, the time for performing an agricultural operation with the header (e.g., a harvesting operation) increases, thereby allowing for improved productivity.

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLURAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

1. A method for aligning an agricultural machine with a tow vehicle for connection therebetween, the method comprising:
determining, with one or more processors, a movement profile of a tongue of the agricultural machine relative to a portion of the agricultural machine, the movement profile corresponding to a plurality of available positions of the tongue along a range of motion;
identifying, with the one or more processors, a target of the tow vehicle;
maneuvering one of the tow vehicle or the agricultural machine relative to the other of the tow vehicle or the agricultural machine; and
ceasing maneuvering of the tow vehicle or the agricultural machine relative to the other of the tow vehicle or the agricultural machine when a position of the target corresponds with one of the plurality of the available positions of the tongue.

2. The method of claim 1, further comprising altering a position of the tongue along the range of motion to cause a position of a coupler provided on the tongue to correspond to the position of the target.

3. The method of claim 2, wherein altering a position of the tongue along the range of motion to cause a coupler provided on the tongue to correspond to the position of the target comprises:
actuating, in response to a first signal from the one or more processors, a first actuator coupled to the tongue of the agricultural machine;
moving the tongue in response to actuation of the first actuator;
determining, with the one or more processors, when the position of the coupler corresponds to the position of the target; and
ceasing actuation of the first actuator when the position of the coupler is determined to correspond to the position of the target.

4. The method of claim 3, wherein the target is a hitch of the tow vehicle.

5. The method of claim 4, further comprising engaging the coupler with the hitch.

6. The method of claim 5, wherein engaging the coupler with the hitch comprises altering a vertical position of at least a portion of the tongue relative to the hitch.

7. The method of claim 6, wherein altering the vertical position of the at least a portion of the tongue relative to the hitch comprises:
actuating, in response to a second signal from the one or more processors, a second actuator to alter the vertical position of the at least portion of the tongue relative to the hitch.

8. The method of claim 2, further comprising:
sensing, with one or more sensors electronically connected to the one or more processors, a location of the agricultural machine;
sensing, with the one or more sensors electronically connected to the one or more processors, a position of the tongue of the agricultural machine; and
defining a curve representing a plurality of available locations of the coupler corresponding to the movement profile of the tongue, and
wherein ceasing maneuvering of the tow vehicle or the agricultural machine relative to other of the tow vehicle or the agricultural machine when a position of the target aligns with one of the plurality of available positions of the tongue comprises ceasing movement of the tow vehicle or the agricultural machine when a position of the target corresponds to a location along the curve.

9. The method of claim 1, further comprising:
sensing, with one or more sensors, an area adjacent to the tow vehicle;
generating a sensor output representative of the area;
detecting, with the one or more processors, a tongue of the agricultural machine in the area using the sensor output; and
determining, with the one or more processors, the range of motion of the tongue relative to the portion of the agricultural machine.

10. The method of claim 9, further comprising detecting, with the one or more processors, that the agricultural machine is present in the area using the sensor output.

11. The method of claim 1, wherein maneuvering one of the tow vehicle or the agricultural machine relative to the other of the tow vehicle or the agricultural machine includes operating a propulsion system of the tow vehicle or the agricultural machine to move one of the tow vehicle or the agricultural machine relative to the other of the tow vehicle or the agricultural machine.

12. The method of claim 1, wherein maneuvering one of the tow vehicle or the agricultural machine relative to the other of the tow vehicle or the agricultural machine includes operating one or more of a steering system or a propulsion system of at least one of the tow vehicle or the agricultural machine.

13. A system to arrange a tow vehicle and an agricultural machine relative to each other for connection, the system comprising:
one or more processors; and
a non-transitory computer-readable storage medium coupled to the one or more processors and storing programming instructions for execution by the one or more processors, the programming instructions instruct the one or more processors to:
determine a movement profile of a tongue of the relative to a portion of the agricultural machine, the profile corresponding to a plurality of available positions of the tongue along a range of motion;
identify a target of the tow vehicle;
maneuver one of the tow vehicle or the agricultural machine relative to the other of the tow vehicle or the agricultural machine; and
cease maneuvering of the tow vehicle or the agricultural machine relative to the other of the tow vehicle or the agricultural machine when a position of the target corresponds with one of the plurality of available positions of the tongue.

14. The system of claim 13, wherein the programming instructions further instruct the one or more processors to alter a position of the tongue along the range of motion to cause a position of a coupler provided on the tongue to correspond to the position of the target.

15. The system of claim 14, wherein the programming instructions that instruct the one or more processors to alter a position of the tongue along the range of motion to cause a position of a coupler provided on the tongue to correspond to the position of the target includes programming instructions that instruct the one or more processors to:
actuate a first actuator coupled to the tongue of the agricultural machine;
move the tongue in response to actuation of the first actuator;
determine when the position of the coupler corresponds to the position of the target; and
cease actuation of the first actuator when the position of the coupler is determined to correspond to the position of the target.

16. The system of claim 15, wherein the target is a hitch of the tow vehicle.

17. The system of claim 16, wherein the programming instructions further instruct the one or more processors to engage the coupler with the hitch.

18. The system of claim 17, wherein the programming instructions that instruct the one or more processors to engage the coupler with the hitch include programming instructions that instruct the one or more processors to alter a vertical position of at least a portion of the tongue relative to the hitch.

19. The system of claim 18, wherein the programming instructions that instruct the one or more processors to alter the vertical position of the at least a portion of the tongue relative to the hitch include programming instructions that instruct the one or more processors to actuate a second actuator to alter the vertical position of the at least portion of the tongue relative to the hitch.

20. The system of claim 14, wherein the programming instructions further instruct the one or more processors to:
sense, with one or more sensors, a location of the agricultural machine;
sense, with the one or more sensors, a position of the tongue of the agricultural machine; and
define a curve representing a plurality of available locations of the coupler corresponding to the movement profile of the tongue.

21. The system of claim 20, wherein the programming instructions that instruct the one or more processors to cease maneuvering of the tow vehicle or the agricultural machine relative to other of the tow vehicle or the agricultural machine when a position of the target aligns with one of the plurality of available positions of the tongue comprises programming instructions that instruct the one or more processors to cease movement of the tow vehicle or the agricultural machine when a position of the target corresponds to a location along the curve.

22. The system of claim 13, wherein the programming instructions further instruct the one or more processors to:
sense, with one or more sensors, an area adjacent to the tow vehicle;
generate a sensor output representative of the area;
detect a tongue of the agricultural machine in the area using the sensor output; and
determine the range of motion of the tongue relative to the portion of the agricultural machine.

23. The system of claim 22, wherein the programming instructions further instruct the one or more processors to detect that the agricultural machine is present in the area using the sensor output.

24. The system of claim 13, wherein the programming instructions that instruct the one or more processors to maneuver one of the tow vehicle or the agricultural machine relative to the other of the tow vehicle or the agricultural machine includes programming instructions that instruct the one or more processors to operate one or more of a steering system or a propulsion system of at least one of the tow vehicle or the agricultural machine.
